(19) United States
(12) Patent Application Publication
(10) Pub. No.: US 2025/0001938 A1
(43) Pub. Date: Jan. 2, 2025

(54) DOOR MIRROR MOUNTING SYSTEM

(71) Applicant: Jaguar Land Rover Limited, Whitley, Coventry, Warwickshire (GB)

(72) Inventors: Daniel HENDERSON, Daventry, Northamptonshire (GB); Matthew GOOD, Daventry, Northamptonshire (GB); Craig WALL, Gaydon, Warwickshire (GB)

(21) Appl. No.: 18/703,682

(22) PCT Filed: Oct. 18, 2022
(86) PCT No.: PCT/EP2022/078984

§ 371 Date: Apr. 22, 2024

(30) Foreign Application Priority Data
Oct. 20, 2021 (GB) 2115041.2

(51) Int. Cl. B60R 1/06; B60J 1/10; B60J 5/04; B60J 10/86

(52) U.S. Cl. CPC B60R 1/06; B60J 10/86; B60J 1/10; B60J 5/0402; B60J 5/0415

(57) ABSTRACT

There is provided a door mirror mounting system (400) for a vehicle door structure (200) and a method (500) of installing a mirror mounting system (400) on a vehicle door structure (200). The door mirror mounting system (400) comprises a reinforcing structure (410) for a window frame portion (210) of the vehicle door structure (200). The reinforcing structure (410) is configured to provide a mounting point for a base (310) of a door mirror (300). The door mirror mounting system (400) comprises an exterior trim panel (420) configured to cover the reinforcing structure (410) and the base (310) of the door mirror (300) when mounted. The exterior trim panel (420) comprises an aperture (424) configured to receive a stem (320) of the door mirror (300) therethrough

### TECHNICAL FIELD

The present disclosure relates to a door mirror mounting system. In particular, but not exclusively it relates to door mirror mounting system for a vehicle door structure which enables a flush finish above the beltline. Aspects of the invention relate to a door mirror mounting system, a vehicle door structure, a method of installing a door mirror mounting system, a method of mounting a door mirror to a vehicle door structure, and a vehicle.

### BACKGROUND

Typically, door mirrors will be mounted to vehicle doors either below the beltline through an aperture in the outer door panel or above the beltline by means of a prominent sail portion which replaces the front quarter light area of a vehicle's glasshouse and sits proud of the adjacent window panels.

### SUMMARY OF THE INVENTION

It is an aim of the present invention to address one or more of the disadvantages associated with the prior art.

Aspects and embodiments of the invention provide a door mirror mounting system, a vehicle door structure, and a vehicle as claimed in the appended claims as well as a method of installing a door mirror mounting system on a vehicle door structure and a method of mounting a door mirror to a vehicle door structure as claimed in the appended claims.

According to an aspect of the invention there is provided a door mirror mounting system for a vehicle door structure. The door mirror mounting system comprises a reinforcing structure for a window frame portion of the vehicle door structure. The reinforcing structure is configured to provide a mounting point for a base of a door mirror. The door mirror mounting system comprises an exterior trim panel configured to cover the reinforcing structure and the base of the door mirror when mounted. The exterior trim panel comprises an aperture configured to receive a stem of the door mirror therethrough.

This provides the advantage of reducing the transmission of forces exerted on the door mirror through the exterior trim panel so that there is greater design freedom for the exterior trim panel and its alignment with adjacent window, body, and trim panels.

Optionally, the door mirror comprises a camera in addition to or instead of an actual mirror surface.

In some examples the reinforcing structure comprises one or more locator elements configured to align the base of the door mirror with fastening points of the window frame portion.

In some examples the one or more locator elements comprise a protrusion configured to cooperate with a stopped groove on the base of the door mirror.

In some examples the one or more locator elements comprise an indentation having a shape substantially corresponding to a shape of the base of the door mirror.

In some examples a lower part of the exterior trim panel is configured to insert into a cavity in the vehicle door structure.

In some examples the outboard facing surface of at least the lower part of the exterior trim panel is flat.

This provides the advantage that there is nothing to catch on the cavity walls and so tolerances in the lower door structure, particularly the outer door panel, are not transferred into the exterior trim panel.

In some examples the outboard facing surface of at least the lower part of the exterior trim panel comprises no engineered protrusions and/or indentations.

This provides the advantage that there is nothing to catch on the cavity walls and so tolerances in the lower door structure, particularly the outer door panel, are not transferred into the exterior trim panel.

In some examples the exterior trim panel comprises an annular seal configured to contact the stem of the door mirror when received through the aperture.

This provides the advantage that the aperture can accommodate the stem with some freedom to float in the x- and z-directions without being a site of leakage.

According to a further aspect of the invention there is provided a vehicle door structure comprising: a window frame portion; a fixed window panel supported by the window frame portion; and the door mirror mounting system. An outboard facing surface of the exterior trim panel is arranged substantially flush with an outboard facing surface of the fixed window panel.

In some examples the fixed window panel terminates above a lower edge of the window frame portion and the exterior trim panel is arranged to cover a resultant gap.

In some examples a lower part of the exterior trim panel is arranged in a cavity in the vehicle door structure into which a movable window panel can be lowered.

In some examples the lower part of the exterior trim panel is arranged in contact with longitudinal sealing strip projecting inboard from an inboard facing surface of the cavity.

In some examples the vehicle door structure comprises a door mirror. The door mirror comprises a housing assembly and a base connected by a stem. The base is fastened to the vehicle door structure via the mounting point provided by the reinforcing structure for the window frame portion. The stem passes through the aperture in the exterior trim panel.

The door mirror may comprise an actual mirrored surface or an external camera. The mirrored surface or camera is housed within the housing assembly.

In some examples the stem of the door mirror extends outboard with clearance over a beltline of the vehicle door structure.

According to a further aspect of the invention there is provided a vehicle comprising the vehicle door structure.

According to a further aspect of the invention there is provided a method of installing a door mirror mounting system on a vehicle door structure. The method comprises providing a reinforcing structure for a window frame portion of the vehicle door structure. The reinforcing structure provides a mounting point for a base of a door mirror. The method comprises providing a fixed window panel supported by the window frame portion. The method comprises covering the reinforcing structure with an exterior trim panel having an outboard facing surface substantially flush with an outboard facing surface of the fixed window panel. The exterior trim panel is arranged to cover the base of the door mirror when mounted and has an aperture configured to receive a stem of the door mirror therethrough.

According to a further aspect of the invention there is provided a method of mounting a door mirror to a vehicle door structure. The method comprises installing a door mirror mounting system on the vehicle door structure by the method of the preceding paragraph. The method comprises passing a base of a door mirror through the aperture in the exterior trim panel and aligning fastening points on the base with fastening points of the window frame portion. The method comprises fastening the base of the door mirror to the window frame portion.

In some examples the base of the door mirror is passed through the aperture in the exterior trim panel while the exterior trim panel is in situ.

This provides the advantage that the exterior trim panel can be shaped according to the gap it covers, aligning with adjacent window, body, and trim panels, rather than limited in shape by necessity that it can be manipulated into the gap between these adjacent panels post hoc.

In some examples a relative orientation between the door mirror and the exterior trim panel are varied between the passing of the base through the aperture and the aligning of fastening points on the base with fastening points of the window frame portion.

Within the scope of this application, it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIGS. 2A and 2B illustrates an example of a door mirror mounting system;

FIG. 3 illustrates an example method of installing a door mirror mounting system to a vehicle door structure;

FIG. 4A to 4E illustrate stages of an example installation of a door mirror mounting system;

FIG. 5A illustrates an example of a reinforcing structure which provides a mounting point for a base of a door mirror; and

FIG. 5B illustrates an example of a base of a door mirror.

### DETAILED DESCRIPTION

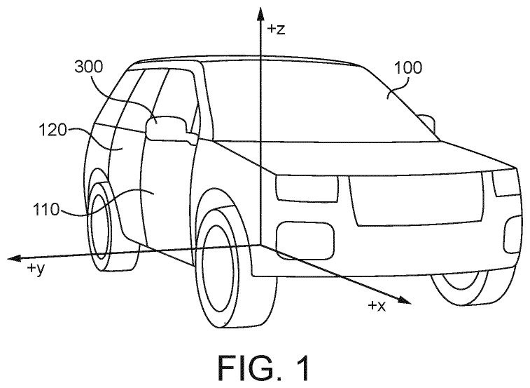

FIG. 1 illustrates an example of a vehicle 100 in which embodiments of the invention can be implemented. In some, but not necessarily all examples, the vehicle 100 is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 100 representing a centreline, an orthogonal lateral y-axis between left and right lateral sides of the vehicle 100, and a vertical z-axis. A forward/fore direction typically faced by a driver's seat is in the positive x-direction; rearward/aft is-x. A rightward direction as seen from the driver's seat is in the positive y-direction; leftward is-y. These are a first lateral direction and a second lateral direction.

The vehicle 100 can comprise any appropriate torque source for delivering tractive torque to vehicle wheels. For example, the vehicle 100 can comprise an electric traction motor. Additionally, or alternatively, the vehicle 100 can comprise an internal combustion engine. The vehicle 100 may be an electric vehicle, a hybrid electric vehicle, an internal combustion engine vehicle, or similar.

The vehicle 100 comprises doors 110, 120 such as the illustrated front side door 110 and rear side door 120. The vehicle doors 110, 120 enable access inboard to the vehicle's cabin and exit outboard from the vehicle's cabin.

A door mirror 300 can be mounted to the front side doors 110 to provide the driver with a view to the rear and to the side of the vehicle. The door mirror 300 can comprise an actual mirrored surface or an external camera. While the mirrored surface requires the driver to look at it to gain the view to the rear and to the side of the vehicle, images captured by the camera may be relayed to an interior screen.

For the purpose of this disclosure the term “vehicle door structure” is used to refer to a structure for a vehicle door that may exclude certain parts/components that would be added by an end manufacturer or a user. Such parts/components could include, for example, an interior trim panel, window panels, hinge(s) for mounting to the vehicle body, handles, etc.

The vehicle door structure 200 can comprise an upper door structure 200U comprising a window frame portion 210 and a lower door structure 200L comprising an outer door panel 220 and an interior frame or panelling configured to support assemblies such as window panel guides and latch mechanism.

The upper door structure 200U can be formed integrally with the lower door structure 200L or formed separately as a module. The lower door structure 200L terminates at the beltline 202.

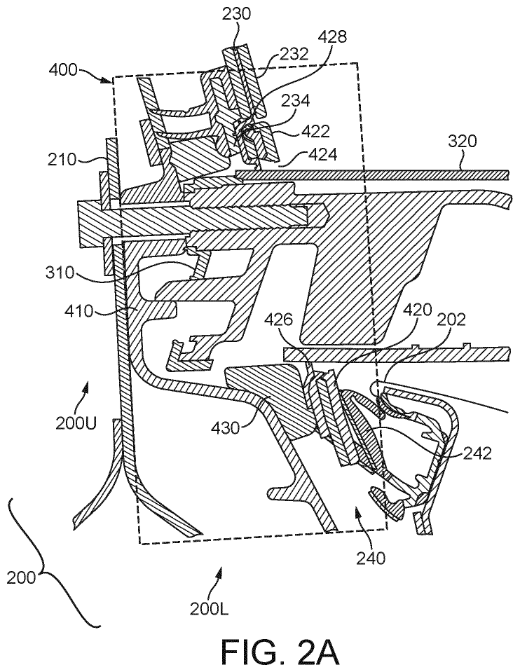

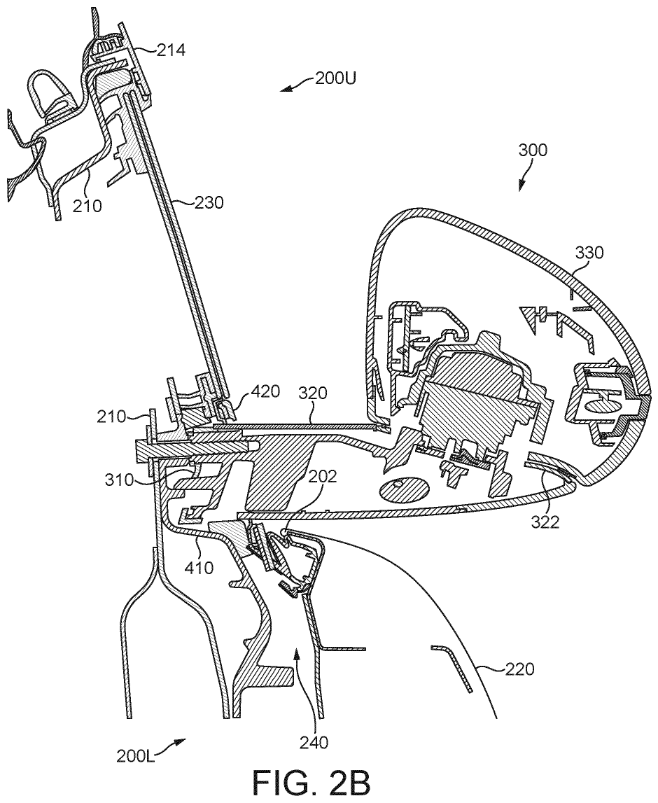

FIGS. 2A and 2B illustrate, in cross section, an example of a door mirror mounting system 400 for a vehicle door structure 200. FIG. 2B shows more of the vehicle door structure 200. The vehicle door structure 200 may be for a front side door 110 of a vehicle 100.

The door mirror 300 to be mounted to the vehicle door structure 200 comprises a base 310 and a mirrored surface or camera within a housing assembly 330 which is connected to the base 310 via a stem 320. The stem 320 may comprise a swing face 322 to enable the housing assembly 330 to be pivot inwards, towards the door structure 200.

In isolation, the window frame portion 210 of the door structure 200 may not present sufficient stiffness in the area to which the door mirror 300 is to be mounted.

Therefore, the door mirror mounting system 400 comprises a reinforcing structure 410 for the window frame portion 210. The reinforcing structure 410 provides a mounting point for the mirror base 310.

The reinforcing structure 410 can reinforce the window frame portion 210 so as, in combination, to resist moments of force due to gravity or drag exerted on the mirror housing assembly 330 and stem 320 during normal use. It may also provide sufficient reinforcement to resist moments of force due to impacts on the mirror housing assembly 330 or stem 320.

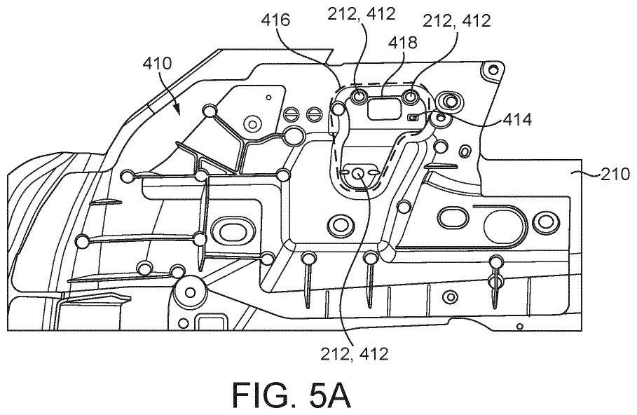

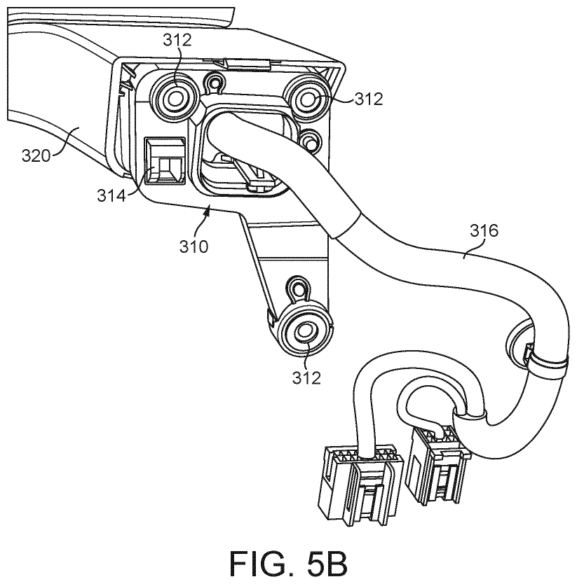

The reinforcing structure 410 may comprise a casting or pressed sheet comprising engineering features configured to provide stiffness such as ribs, bosses, and other reliefs, as can be seen in the example reinforcing structure 410 illustrated in FIG. 5A. Elements of the shape of the reinforcing structure 410 may conform to the contours of the window frame portion 210 on which it is provided.

The door mirror mounting system 400 additionally comprises an exterior trim panel 420 configured to cover the reinforcing structure 410 and also the base 310 of the door mirror 300 when mounted.

The exterior trim panel 420 may seal onto one or more adjacent window panels supported by the window frame portion 210. To avoid transmitting into these adjacent window panels forces which are exerted on the mirror housing assembly 330 or stem 320 or clamp loads involved in fastening the base 310 to the door structure 200, the exterior trim panel 420 is divorced from the door mirror 300.

To achieve this, the exterior trim panel 420 comprises an aperture 424 configured to receive the stem 320 of the door mirror 300 therethrough.

In some examples, the aperture 424 is sized to accommodate the stem 320 with some freedom to float in the x- and z-directions.

In some examples, the aperture 424 and stem 320 have cooperating profiles configured to limit the relative orientations of the mirror 300 and exterior trim panel 420. They may comprise, for example, mating splines. Said profiles may be asymmetric. This can enable the aperture 424 to function as a locator element which is configured to cause alignment of fastening points 312 on the mirror base 310 with fastening points 212 of the window frame portion 210 when the stem 320 is received therethrough.

In some examples, the exterior trim panel 420 comprises an annular seal 426 configured to contact the stem 320 of the door mirror 300 when received through the aperture 424. In some examples the annular seal 426 may perform as a bushing between the exterior trim panel 420 and the mirror stem 320. The annular seal 426 may be affixed to an inboard or outboard facing surface of the exterior trim panel 420, thus providing a narrower, but flexible, secondary aperture inboard or outboard of the aperture 424. Alternatively, the annular seal 426 may be affixed to the inner perimeter of the aperture 424.

In some examples, the annular seal 426 and stem 320 have cooperating profiles configured to limit the relative orientations of the mirror 300 and exterior trim panel 420 They may comprise, for example, mating splines. Said profiles may be asymmetric. This can enable the annular seal 426 to function as a locator element which is configured to cause alignment of fastening points 312 on the mirror base 310 with fastening points 212 of the window frame portion 210 when the stem 320 is received therethrough.

The divorce of the exterior trim panel 420 from the door mirror 300 has the additional advantage that forces or loads to which the door mirror 300 is subjected will not cause the exterior trim panel 420 to distort if it is made substantially flat. Therefore, in some examples the exterior trim panel 420 is made substantially flat.

In some examples an outboard facing surface 422 of the exterior trim panel 420 is arranged substantially flush with one or more outboard facing surfaces of one or more adjacent window panels. It may also be arranged substantially flush with one or more outboard facing surfaces of one or more body or trim panels.

In some examples the door structure 200 comprises a fixed window panel 230 supported by the window frame portion 210. The fixed window panel 230 provides a front quarter light. The outboard facing surface 422 of the exterior trim panel 420 is arranged substantially flush with an outboard facing surface 232 of the fixed window panel 230. The fixed window panel 230 in this example terminates above a lower edge of the window frame portion 210 and above the beltline 202. The exterior trim panel 420 is arranged to cover the resultant gap.

In some examples the exterior trim panel 420 comprises a perimeter seal 428 which seals the exterior trim panel 420 back to one or more adjacent window panels with a low clamp load.

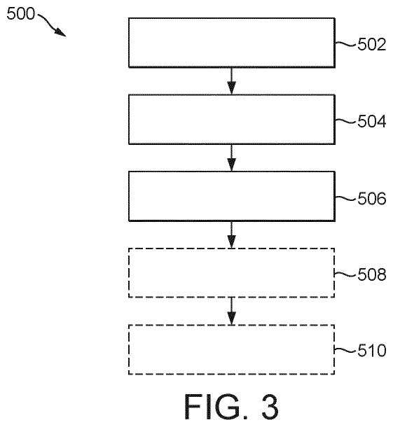

FIG. 3 illustrates a method 500 of installing the aforementioned door mirror mounting system 400 on the vehicle door structure 200.

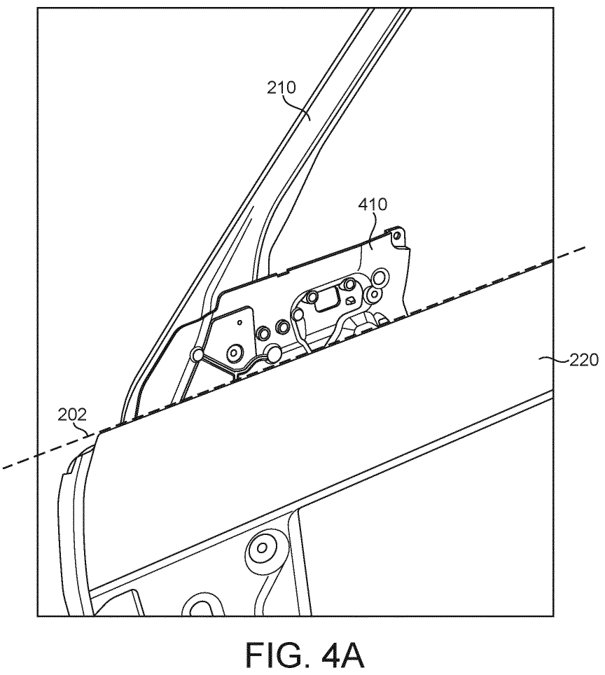

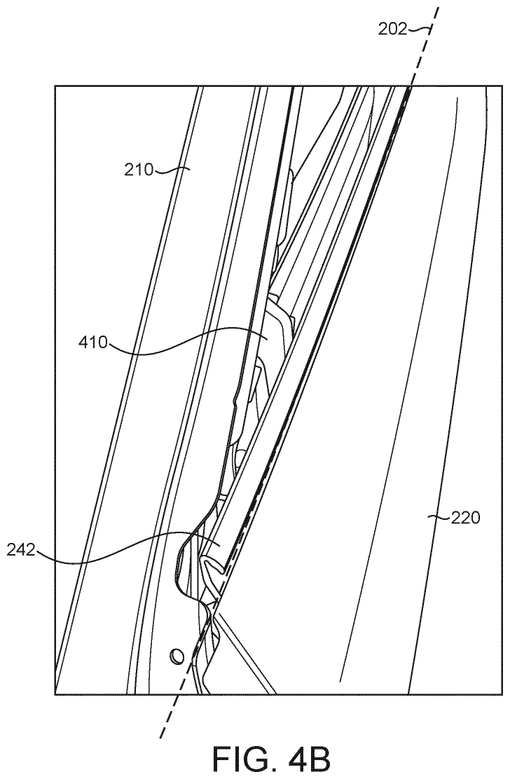

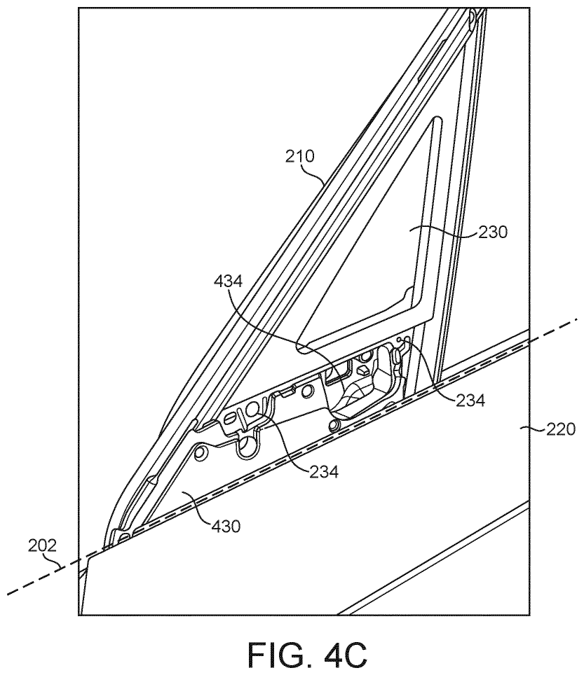

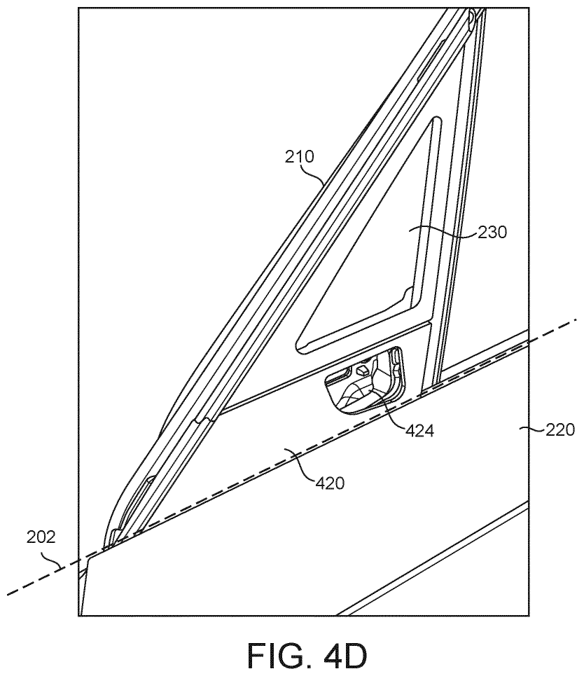

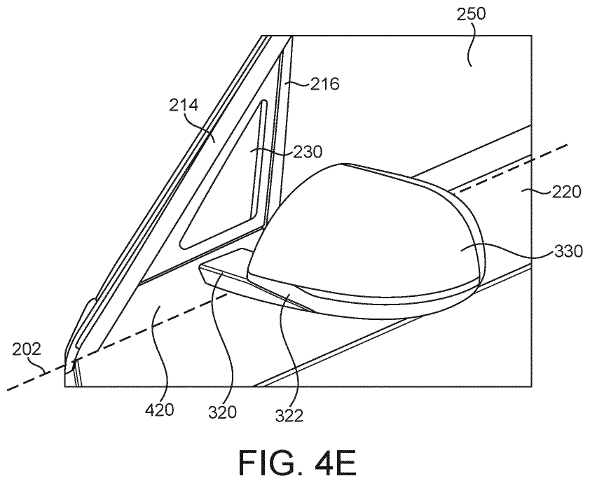

The method 500 is described in conjunction with FIG. 4A to 4E which illustrate the vehicle door structure 200 at various stages of the installation of the door mirror mounting system 400.

Block 502 of the installation method 500 comprises reinforcing the window frame portion 210 of the vehicle door structure 200 to provide a mounting point for the door mirror 300. This is achieved by providing the reinforcing structure 410 for the window frame portion 210 of the vehicle door structure 200. The reinforcing structure 410 may be cast and mechanically fastened to the window frame portion 210 by, for example, rivets. Additionally or alternatively, the, or a part of the, reinforcing structure 410 may be formed by pressing engineering features configured to provide stiffness into the window frame portion 210. The reinforcing structure 420 provides the mounting point for the base 310 of the door mirror 300.

FIG. 4A illustrates the result of block 502: a vehicle door structure 200 comprising the reinforcing structure 410 reinforcing the window frame portion 210. As can be seen, in this example the reinforcing structure 410 extends below the beltline 202. There is partial overlap between the reinforcing structure 410 and the outer door panel 220.

In some examples a sealing strip 242 is installed below the beltline 202 in a cavity 240 within the vehicle door structure 200 (in particular, within the lower door structure 200L) into which the movable window panel 240 can be lowered. The sealing strip 242 extends longitudinally, substantially parallel with the beltline 202. The sealing strip 242 projects inboard from an inboard facing surface of the cavity 240 and is configured to make sealing contact with objects sliding into and out of the cavity 240 such as the movable window panel 250. In the example illustrated in FIG. 4B, the sealing strip 242 has been installed prior to block 504 of the method 500 but it is to be understood that it could be installed after block 504 provided that its installation precedes block 506.

At block 504 of the installation method 500 the fixed window panel 230 is provided, supported by the window frame portion 210. The fixed window panel 230 can be fitted within the opening defined by window frame portion 210 such that it terminates above a lower edge of the window frame portion 210, resulting in a gap which exposes the reinforcing structure 410 (or, as shown in FIG. 4C, any spacer 430 overlying the reinforcing structure 410). A mechanical fixing may be used to secure the upper edge of the fixed window panel 230 to the window frame portion 210.

In some examples the fixed window panel 230 fastens to reinforcing structure 410 via a bracket 234 running along a lower edge of the panel's inboard facing surface, as shown in FIG. 4C. By providing the bracket 234 on the inboard facing surface, the outboard facing surface 232 can be made flush with adjacent surfaces.

Block 506 of the installation method 500 comprises covering the reinforcing structure 410 with the exterior trim panel 420, the result of which is illustrated in FIG. 4D.

This can involve fitting the exterior trim panel 420 such that it covers the gap resulting from the termination of the fixed window panel 220 above a lower edge of the window frame portion 210.

The exterior trim panel 420 can be fitted with its outboard facing surface 422 substantially flush with the outboard facing surface 232 of the fixed window panel 230. To facilitate this, an appropriately sized spacer 430 may be provided between the reinforcing structure 410 and the exterior trim panel 420. The spacer 430 comprises its own aperture 434, cooperating with the aperture 424 to provide a passage for the base 310 of the door mirror 300 through to mounting alignment with the reinforcing structure 410. The spacer 230 may be distinct from the reinforcing structure 410 and the exterior trim panel 420 or may be integrally formed with one of them. The spacer 430 can be formed from an insulating material.

In some examples the fitting of the exterior trim panel 420 comprises sliding insertion of the panel 420 substantially downwards into the cavity 240 so that a lower part of the exterior trim panel 420 is positioned below the beltline 202, inboard of the outer door panel 220 of the lower door structure 200L. Once fitted, there is partial overlap between the exterior trim panel 420 and the outer door panel 220. The outboard facing surface 422 of the exterior trim panel 420 is, in such examples, positioned in sealing contact with the sealing strip 242. To be clear, the exterior trim panel 420 is not inserted into the space into which the movable window panel can be lowered but rather a continuation of that space in the form of the cavity 240.

To facilitate the insertion, particularly the sliding insertion, of the exterior trim panel 420 into the cavity 240, the lower part of the exterior trim panel 420 is accordingly configured. For example, its outboard facing surface 422 can be configured to move, and in particular slide substantially vertically, relative to an inboard facing surface of the cavity 240 or its upper edge without catching. Accordingly, the outboard facing surface 422 of the exterior trim panel 420 is flat at least where it is, or will be during the sliding insertion, adjacent to an inboard facing surface of the cavity 240. That is, the outboard facing surface 422 of at least the lower part of the exterior trim panel 420 is flat. The outboard facing surface 420 may comprise no engineered protrusions and/or indentations in the area which is, or will be during the sliding insertion, adjacent to the inboard facing surface of the cavity 240. That is, the outboard facing surface 422 of at least the lower part of the exterior trim panel 420 comprises no engineered protrusions and/or indentations.

Additionally, once the exterior trim panel 420 is in situ, its outboard facing surface's flatness or lack of engineered protrusions and/or indentations in the area adjacent to the inboard facing surface of the cavity 240 means that any tolerances in the vertical length of the outer door panel 220 are not transferred into the exterior trim panel 420. Avoidance of this is advantageous because the transfer of these tolerances into the exterior trim panel 420 can cause deformation of the exterior trim panel 420 and/or misalignment between the aperture 424 and the position of the mirror stem 320 such that there is difficulty aligning the mirror base 310 for fastening to the door structure 200 or such that the stem 320 may be deformed. Deformation of the stem 320 can affect the swing face 322 such that the pivoting of the housing assembly 330 with respect to the vehicle body is compromised.

Blocks 508 and 510 optionally extend the method 500 of installing the door mirror mounting system 400 to a method of installing the door mirror 300 on the vehicle door structure 200. The resultant vehicle door structure 200 comprising the door mirror 300 fastened thereto is shown in FIG. 4E.

Block 508 comprises passing the base 310 of the door mirror 300 through the aperture 424 in the exterior trim panel 420 and aligning fastening points 312 (see FIG. 5B) on the base 310 with fastening points 212 (see FIG. 5A) of the window frame portion 210.

In some examples, the base 310 of the door mirror 300 is passed through the aperture 424 in the in situ exterior trim panel 420. In other words, block 508 is performed subsequent to block 506.

In some examples, a relative orientation between the door mirror 300 and the exterior trim panel 420 is varied between the passing of the base 310 through the aperture 424 and the aligning of fastening points 312 on the base 310 with fastening points 212 of the window frame portion 210. For example, the base 310 may extend perpendicularly from the stem 320 such that its area is larger than that of the aperture 424. To insert this base 310 through the aperture 424, the stem 320 may be inclined so as to reduce the projected area of the base 320 with respect to the exterior trim panel 420 and aperture 424 therein. Once the base 310 has been passed through the aperture 424, the door mirror 300 may be tilted to bring the stem 320 to a substantially level orientation and to align the base 310 with the mounting point provided by the reinforcing structure 410.

It is to be appreciated that in some examples of the method 500, the mirror base 310 can be posted through the aperture 424 before the exterior trim panel 420 is fitted as according to block 506. The aligning of fastening points 312 on the base 310 with fastening points 212 of the window frame portion 210 may then be performed substantially contemporaneously with the fitting of the exterior trim panel 420.

Block 510 comprises fastening the base 310 of the door mirror 300 to the window frame portion 210.

In the resultant vehicle door structure 200, as shown in FIG. 4E, the stem 320 of the door mirror 300 extends outboard with clearance over the beltline 202 while retaining a window panel in the front quarter light area. In some examples the outboard facing surface 422 of the exterior trim panel 420 is arranged substantially flush with not only an outboard facing surface 232 of the fixed window panel 230 but also the outboard facing surfaces of the movable window panel 250, the upper window frame trim 214 and the dividing trim 216 between the fixed and movable window panels 230, 250. Accordingly, a flush finish above the beltline 202 can be achieved. This can be extended to provide a flush glasshouse for the vehicle 100.

The illustration of a particular order to the blocks does not necessarily imply that there is a required or preferred order for the blocks and the order and arrangement of the block may be varied. Furthermore, it may be possible for some steps to be omitted.

To assist in the alignment of fastening points 312 on the base 310 with fastening points 212 of the window frame portion 210, the reinforcing structure 410 and the base 310 can be provided cooperating profiles as illustrated in FIGS. 5A and 5B.

The reinforcing structure 410 can comprise one or more locator elements configured to align fastening points 312 on the base 310 with fastening points 212 of the window frame portion 210.

For example, the reinforcing structure 410 can comprise an indentation 416 configured to receive the base 310 of the door mirror. The indentation 416 may, as illustrated, have shape substantially corresponding to a shape of the base 310 of the door mirror 300.

For example, the reinforcing structure 410 can comprise a protrusion 414 configured to cooperate with a stopped groove 314 on the base 310 of the door mirror 300. The stopped groove 314 may be open at its lower end and stopped at its upper end. This enables the path of the mirror base 310 from insertion through the aperture 424 in the exterior trim panel 420 into a mounting alignment to involve a downward component as well as a lateral component.

The walls of the stopped groove 314 prevent longitudinal misalignment. The reinforcing structure 410 comprises the protrusion 414 and the base 310 comprises the stopped groove 314 rather than the other way around so that there are minimal protrusions from the base 310 which could catch, be damaged, or cause damage during the passing of the base 310 through the aperture 424.

The reinforcing structure 410 comprises a plurality of through-holes 412 distributed in the same arrangement as the fastening points 312 on the base 310 and fastening points 212 of the window frame portion 210. This enables the base 310 to fastened to the window frame portion 210 through the reinforcing structure 410.

In some examples the reinforcing structure 410 comprises an aperture 418 to enable a cable harness 340 for electronic components of the door mirror 300 to be passed inboard. During installation of the door mirror 300, the cable harness 340 may be passed through the aperture 424 in the exterior trim panel 420 and this aperture 418 in the reinforcing structure 410 before the base 310 of the door mirror 300 is passed through the aperture 424 in the exterior trim panel 420.

It will be appreciated that various changes and modifications can be made to the present invention without departing from the scope of the present application.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A door mirror mounting system for a vehicle door structure, the door mirror mounting system comprising:
a reinforcing structure for a window frame portion of the vehicle door structure, the reinforcing structure configured to provide a mounting point for a base of a door mirror; and
an exterior trim panel configured to cover the reinforcing structure and the base of the door mirror when mounted and the exterior trim panel comprising an aperture configured to receive a stem of the door mirror therethrough.

2. The door mirror mounting system of claim 1 wherein the reinforcing structure comprises one or more locator elements configured to align the base of the door mirror with fastening points of the window frame portion.

3. The door mirror mounting system of claim 2 wherein the one or more locator elements comprise a protrusion configured to cooperate with a stopped groove on the base of the door mirror.

4. The door mirror mounting system of claim 2 wherein the one or more locator elements comprise an indentation having a shape substantially corresponding to a shape of the base of the door mirror.

5. The door mirror mounting system of claim 1 wherein a lower part of the exterior trim panel is configured to insert into a cavity in the vehicle door structure.

6. The door mirror mounting system of claim 5 wherein the outboard facing surface of at least the lower part of the exterior trim panel is flat.

7. The door mirror mounting system of claim 5 wherein the outboard facing surface of at least the lower part of the exterior trim panel comprises no engineered protrusions and/or indentations.

8. The door mirror mounting system of claim 1 wherein the exterior trim panel comprises an annular seal configured to contact the stem of the door mirror when received through the aperture.

9. A vehicle door structure comprising:
a window frame portion;
a fixed window panel supported by the window frame portion; and
the door mirror mounting system of claim 1,
wherein an outboard facing surface of the exterior trim panel is arranged substantially flush with an outboard facing surface of the fixed window panel.

10. The vehicle door structure of claim 9 wherein the fixed window panel terminates above a lower edge of the window frame portion and the exterior trim panel is arranged to cover a resultant gap.

11. The vehicle door structure of claim 9 wherein a lower part of the exterior trim panel is arranged in a cavity in the vehicle door structure into which a movable window panel can be lowered.

12. The vehicle door structure of claim 11 wherein the lower part of the exterior trim panel is arranged in contact with longitudinal sealing strip projecting inboard from an inboard facing surface of the cavity.

13. The vehicle door structure of claim 9 comprising a door mirror, the door mirror comprising a housing assembly and a base connected by a stem, the base being fastened to the vehicle door structure via the mounting point provided by the reinforcing structure for the window frame portion, and the stem passing through the aperture in the exterior trim panel.

14. The vehicle door structure of claim 13 wherein the stem of the door mirror extends outboard with clearance over a beltline of the vehicle door structure.

15. A vehicle comprising the vehicle door structure of claim 9.

16. A method of installing a door mirror mounting system on a vehicle door structure, the method comprising:
providing a reinforcing structure for a window frame portion of the vehicle door structure, the reinforcing structure providing a mounting point for a base of a door mirror;
providing a fixed window panel supported by the window frame portion;
covering the reinforcing structure with an exterior trim panel having an outboard facing surface substantially flush with an outboard facing surface of the fixed window panel,
wherein the exterior trim panel is arranged to cover the base of the door mirror when mounted and has an aperture configured to receive a stem of the door mirror therethrough.

17. A method of mounting a door mirror to a vehicle door structure, the method comprising:
installing a door mirror mounting system on the vehicle door structure by the method of claim 16;
passing a base of a door mirror through the aperture in the exterior trim panel and aligning fastening points on the base with fastening points of the window frame portion; and
fastening the base of the door mirror to the window frame portion.

18. The method of claim 17, wherein the base of the door mirror is passed through the aperture in the exterior trim panel while the exterior trim panel is in situ.

19. The method of claim 17, wherein a relative orientation between the door mirror and the exterior trim panel are varied between the passing of the base through the aperture and the aligning of fastening points on the base with fastening points of the window frame portion.
